(19) United States
(12) Patent Application Publication
(10) Pub. No.: US 2024/0413328 A1
(43) Pub. Date: Dec. 12, 2024

(54) LITHIUM SECONDARY BATTERY HAVING HIGH ENERGY DENSITY

(71) Applicant: LG Energy Solution, Ltd., Seoul (KR)

(72) Inventors: Da-Young Kang, Daejeon (KR); Bong-Soo Kim, Daejeon (KR); So-Young Kim, Daejeon (KR); Ji-Hoon Ahn, Daejeon (KR); Jung-Hoon Han, Daejeon (KR)

(21) Appl. No.: 18/506,592

(22) Filed: Nov. 10, 2023

(30) Foreign Application Priority Data
Jun. 9, 2023 (KR) 10-2023-0074500

(51) Int. Cl. H01M 4/583; H01M 4/02; H01M 4/58; H01M 10/04; H01M 50/105

(52) U.S. Cl. CPC H01M 4/583; H01M 4/5815; H01M 10/0422; H01M 50/105; H01M 2004/021; H01M 2004/027; H01M 2004/028

(57) ABSTRACT

A lithium-sulfur battery having high energy density and a method for manufacturing the same are provided. The lithium-sulfur battery at depth of discharge (DOD) 15% to DOD 80% includes a compound having three or more characteristic peaks of diffraction angles (2θ values) of X-ray diffraction (XRD) patterns selected from 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2°.

### CROSS-REFERENCE TO RELATED APPLICATIONS

This application claims the benefit of and priority to Korean Patent Application No. 10-2023-0074500, filed on Jun. 9, 2023, the disclosures of which are incorporated herein by reference in their entirety.

### TECHNICAL FIELD

The present disclosure relates to a lithium secondary battery, particularly a lithium-sulfur battery having high energy density.

### BACKGROUND ART

As the applications of a lithium secondary battery expands from portable electronic devices to electric vehicle (EVs) and electric storage systems (ESSs), the demand for a lithium secondary battery with high capacity, high energy density and long lifetime is increasing.

Among various lithium secondary batteries, a lithium-sulfur battery is a battery system which uses a sulfur-based material containing a sulfur-sulfur bond as a positive electrode active material and uses lithium metal, a carbon-based material wherein intercalation/deintercalation of lithium ions occurs, silicon or tin that forms an alloy with lithium, etc. as a negative electrode active material.

In the lithium-sulfur battery, sulfur, which is the main material of the positive electrode active material, is advantageous in that it has a small weight per atom, is abundant, easily available and inexpensive, is non-toxic, and is environment-friendly.

In addition, the lithium-sulfur battery exhibits a theoretical specific capacity of 1,675 mAh/g for a positive electrode where the conversion of lithium ions and sulfur occurs (S₈+16Li⁺+16e⁻→8Li₂S) and a theoretical energy density of 2,600 Wh/kg for a negative electrode using lithium metal. Since it exhibits very high theoretical energy density than other currently studied battery systems (Ni-MH battery: 450 Wh/kg, Li—FeS battery: 480 Wh/kg, Li—MnO₂ battery: 1,000 Wh/kg, Na—S battery: 800 Wh/kg, lithium-ion battery: 250 Wh/kg), it is attracting attentions as a high-capacity, environment-friendly and inexpensive lithium secondary battery among the secondary batteries that are being developed currently.

However, the energy density is not high enough because the theoretical capacity is not fully realized due to the large amount of electrolyte, decreased efficiency of the positive electrode, degeneration of the negative electrode, etc.

Therefore, research is being conducted continuously to realize a lithium secondary battery having high energy density.

### SUMMARY

The present disclosure is related to providing a lithium-sulfur battery having high energy density.

In an aspect, the present disclosure provides a lithium-sulfur battery according to the following exemplary embodiments.

A lithium-sulfur battery according to a first exemplary embodiment includes: an electrode assembly which comprises a positive electrode including a sulfur-carbon composite, a negative electrode, and a separator between the positive electrode and the negative electrode; and an electrolyte, and the lithium-sulfur battery at depth of discharge (DOD) 15% to DOD 80% includes a compound having three or more characteristic peaks of diffraction angles (2θ values) of X-ray diffraction (XRD) patterns selected from 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2°.

According to a second exemplary embodiment, in the first exemplary embodiment, the lithium-sulfur battery at DOD 15% to DOD 80% may have a potential of from 1.7 to 2.2 V.

According to a third exemplary embodiment, in the first or second exemplary embodiment, the DOD 15% to DOD 80% may be a state having a discharge capacity per sulfur(S) weight of from 150 to 960 mAh/g(S).

According to a fourth exemplary embodiment, in any of the first to third exemplary embodiments, the compound may have four or more characteristic peaks of the diffraction angles (2θ values) of XRD patterns selected from 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2°.

According to a fifth exemplary embodiment, in any one of the first to fourth exemplary embodiments, the compound may have XRD pattern diffraction angles (2θ values) of 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2°.

According to a sixth exemplary embodiment, in any one of the first to fifth exemplary embodiments, the sulfur-carbon composite may have a sulfur/carbon (S/C) weight ratio of 2.3 g/g or more.

According to a seventh exemplary embodiment, in any one of the first to sixth exemplary embodiments, the weight of the sulfur-carbon composite may be 90 wt % or more based on the total weight of the positive electrode.

According to an eighth exemplary embodiment, in any one of the first to seventh exemplary embodiments, the positive electrode may have a sulfur(S) loading amount of from 2 to 5 mAh/cm².

According to a ninth exemplary embodiment, in any one of the first to eighth exemplary embodiments, the negative electrode may have a thickness of from 40 to 80 μm.

According to a tenth exemplary embodiment, in any one of the first to ninth exemplary embodiments, a weight ratio of the electrolyte solution and sulfur(S) in the sulfur-carbon composite (El/S weight ratio) may be 2.5 g/g or lower.

According to an eleventh exemplary embodiment, in any one of the first to tenth exemplary embodiments, the lithium-sulfur battery has Sₓ, a ratio of the sulfur(S) loading amount of the positive electrode to the weight ratio of the electrolyte solution and sulfur(S) according to the following Equation 1, of 1.4 mAh/cm² or more,

$${S}_{X} = {S}_{PE} / {S}_{EI / S} , \qquad [ Equation 1 ]$$

wherein S_{PE} is the sulfur(S) loading amount of the positive electrode in the unit of mAh/cm², and

S_{EL/S} is the weight ratio of the electrolyte solution and sulfur(S).

According to a twelfth exemplary embodiment, in the eleventh exemplary embodiment, the lithium-sulfur battery has Sₓ of from 1.4 to 10 mAh/cm².

According to a thirteenth exemplary embodiment, in any one of the first to twelfth exemplary embodiments, the lithium-sulfur battery may have an energy density of 430 Wh/kg or more.

According to a fourteenth exemplary embodiment, in any one of the first to thirteenth exemplary embodiments, the lithium-sulfur battery may be a pouch-type battery or a cylindrical battery.

In another aspect, the present disclosure provides a method for evaluating an energy density of a lithium-sulfur battery.

According to a fifteenth exemplary embodiment, the method for evaluating an energy density of a lithium-sulfur battery, the lithium-sulfur battery including an electrode assembly which comprises a positive electrode including a sulfur-carbon composite, a negative electrode and a separator between the positive electrode and the negative electrode; and an electrolyte, includes a step of determining a lithium-sulfur battery including a compound having three or more characteristic peaks selected from diffraction angles (2θ values) 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2° in the X-ray diffraction (XRD) pattern at DOD 15% to DOD 80% as a battery having high energy density.

According to a sixteenth exemplary embodiment, in the fifteenth exemplary embodiment, the battery having high energy density, for example, may be a battery having an energy density of 430 Wh/kg or higher.

A lithium-sulfur battery according to an aspect of the present disclosure has high energy density.

In particular, the lithium-sulfur battery of the present disclosure may have an energy density of 300 Wh/kg or higher, or 430 Wh/kg or higher.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not to be construed as being limited to the drawings.

FIG. 1 shows a result of evaluating discharge capacity for Example 1, Comparative Example 2 and Comparative Example 3.

FIG. 2A shows the real-time charge/discharge XRD patterns of the lithium-sulfur battery of Example 1. In FIG. 2A, the XRD patterns at the diffraction angles 20 (theta) for the corresponding constituent materials in the lithium-sulfur battery are shown. FIG. 2B is a line graph of the XRD results of Example 1 at DOD 22% of the lithium-sulfur battery.

FIG. 3A shows the real-time charge/discharge XRD patterns of the lithium-sulfur battery of Comparative Example 1. In FIG. 3A, the XRD patterns at the diffraction angles 20 (theta) for the corresponding constituent materials in the lithium-sulfur battery are shown. FIG. 3B is a line graph of the XRD results of Comparative Example 1 at DOD 22% of the lithium-sulfur battery.

FIG. 4A shows the real-time charge/discharge XRD patterns of the lithium-sulfur battery of Comparative Example 2. In FIG. 4A, the XRD patterns at the diffraction angles 20 (theta) for the corresponding constituent materials in the lithium-sulfur battery are shown. FIG. 4B is a line graph of the XRD results of Comparative Example 2 at DOD 22% of the lithium-sulfur battery.

FIG. 5A shows the real-time charge/discharge XRD patterns of the lithium-sulfur battery of Comparative Example 3. In FIG. 5A, the XRD patterns at the diffraction angles 20 (theta) for the corresponding constituent materials in the lithium-sulfur battery are shown.

FIG. 5B is a line graph of the XRD results of Comparative Example 3 at DOD 22% of the lithium-sulfur battery.

### DETAILED DESCRIPTION

Hereinafter, the present disclosure is described in more detail.

The terms or words used in the present disclosure and claims should not be construed as being limited to their ordinary or dictionary meanings, and should be interpreted as meanings and concepts consistent with the technical idea of the present disclosure based on the principle that an inventor may properly define the concept of terms to best explain his/her invention.

In addition, throughout the specification, when a part is described to “include (or comprise)”, “have” or “be equipped with” a certain component, it means that it can further include other components rather than excluding other components, unless stated otherwise.

In addition, as used throughout the present disclosure, the terms such as ‘about’, ‘substantially’, etc. are used to indicate that the stated numerical value is close to a specific value within the allowable error, and are used to aid in the understanding of the present disclosure and prevent improper use of the present disclosure by an unscrupulous infringer.

Throughout the present disclosure, the description ‘A and/or B’ means ‘A or B’ or ‘A and B’.

Throughout the present disclosure, temperature is indicated on the Celsius scale, in ° C. unit, unless specified otherwise.

The term “composite” used in the present disclosure refers to a material which exhibits more effective functions as two or more different materials are combined to form physically or chemically different phases.

The term “(poly)sulfide” used in the present disclosure includes both “(poly) sulfide ions (Sₓ²⁻, 1≤x≤8)” and “lithium (poly) sulfides (Li₂Sₓ or Li₂Sₓ⁻, 1≤x≤8)”.

The term “polysulfide” used in the present disclosure includes both “polysulfide ions (Sₓ²⁻, 1<x≤8)” and “lithium polysulfides (Li₂Sₓ or Li₂Sₓ⁻, 1<x≤8)”.

In an aspect, the present disclosure provides a lithium-sulfur battery having high energy density.

The lithium-sulfur battery according to an aspect of the present disclosure includes: an electrode assembly including a positive electrode including a sulfur-carbon composite, a negative electrode and a separator disposed between the positive electrode and the negative electrode; an electrolyte; and a case in which the electrode assembly is accommodated, and includes a compound having three or more characteristic peaks selected from diffraction angles (2θ values) 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2° in the X-ray diffraction (XRD) pattern at DOD 15% to DOD 80%.

The lithium-sulfur battery according to an aspect of the present disclosure includes a compound having the above-described XRD pattern in the discharged state. The lithium-sulfur battery includes inorganic sulfur (S₈) as a positive electrode active material. In the lithium-sulfur battery lithium polysulfide is formed through reduction at the positive electrode during discharge. The compound may be crystalline form of lithium polysulfide formed through reduction of inorganic sulfur (S₈). The lithium-sulfur battery according to an aspect of the present disclosure may exhibit high energy density because it includes crystalline form of lithium polysulfide which has the above-described XRD pattern in the discharged state.

In an exemplary embodiment of the present disclosure, the compound may be crystalline form of lithium polysulfide, wherein the lithium polysulfide may be at least one of Li₂Sₓ and Li₂Sₓ⁻ (1<x≤8).

In the present disclosure, the compound may be defined as a crystalline form of lithium polysulfide having three or more characteristic peaks selected from diffraction angles (2θ values) 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2° in the X-ray diffraction (XRD) pattern at DOD 15% to DOD 80%.

In an exemplary embodiment of the present disclosure, the compound may be a crystalline form of lithium polysulfide formed under a high energy density condition during the discharge of a lithium-sulfur battery having high energy density. For example, the lithium-sulfur battery having high energy density may have a low El/S (electrolyte/sulfur) ratio as will be described later and a crystalline form exhibiting the characteristic diffraction angle peaks in the XRD pattern may be formed as the lithium polysulfide formed during the operation of the lithium-sulfur battery is dissolved in the low-content electrolyte at a high concentration, although the mechanism of the formation of the compound is not limited thereto.

In an exemplary embodiment of the present disclosure, the compound may have four or more, for example, five or more, characteristic peaks selected from the diffraction angles (2θ values) described above. Specifically, it may have 3, 4, 5, 6, 7, 8, 9, 10 or 11 characteristic peaks.

In an exemplary embodiment of the present disclosure, the compound may include diffraction angles (2θ values) 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2° in the XRD pattern.

In an exemplary embodiment of the present disclosure, the compound may have diffraction angles (2θ values) 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2° in the XRD pattern.

In an exemplary embodiment of the present disclosure, the compound may be included on at least one of the inner surfaces of the positive electrode, the negative electrode, the separator, the electrolyte and the case of the lithium-sulfur battery, and the XRD pattern may be obtained through non-destructive analysis of the lithium-sulfur battery. That is to say, the XRD pattern may be measured without disassembling the lithium-sulfur battery.

In an exemplary embodiment of the present disclosure, the XRD pattern may be obtained from the lithium-sulfur battery. Specifically, the XRD pattern may be obtained through non-destructive analysis of the lithium-sulfur battery. For example, it may be obtained through operando X-ray diffraction (operando XRD) analysis. More specifically, the XRD pattern may be obtained by measuring 2 theta (20) values in the range of 7-17° at room temperature (23° C.) using Mo K-alpha X-ray (λ=0.709 Å) of PANalyical Empyrean XRD in transmission mode. Each pattern may be obtained for a total of 3 minutes at 0.014° intervals.

In an aspect of the present disclosure, since the compound having the XRD pattern is included in the discharged state of the lithium-sulfur battery, the XRD measurement and the charge/discharge of the lithium-sulfur battery may be conducted at the same time. Specifically, the XRD measurement may be conducted continuously while the lithium-sulfur battery is being charged/discharged. More specifically, the XRD patterns are obtained by real-time charge/discharge XRD measurement through operando XRD analysis.

In an exemplary embodiment of the present disclosure, when the lithium-sulfur battery is a pouch-type battery, a pressing jig equipped with a Be-window may be used for the XRD measurement during the operation of the lithium-sulfur battery, although the present disclosure is not limited thereto.

As described above, the XRD pattern of the compound may be obtained in the discharged state of the lithium-sulfur battery. The discharged state for obtaining the XRD pattern is a state of DOD (depth of discharge) 15% to DOD 80%.

In the present disclosure, the state of DOD 15% to DOD 80% refers to a state in which the lithium-sulfur battery is discharged by 15-80% from the fully charged state, i.e., SoC (state of charge) 100%.

In an exemplary embodiment of the present disclosure, the DOD 15% may be a state with a potential of 2.2 V or lower, and the state of DOD 15% to DOD 80% may be, for example, a state with a potential of 1.7-2.2 V, although the present disclosure is not limited thereto.

In an exemplary embodiment of the present disclosure, the total discharge capacity of the lithium-sulfur battery may be 1,000 mAh/g(S) or higher per sulfur(S) weight. For example, the total discharge capacity of the lithium-sulfur battery may be 1,000-1,300 mAh/g(S), specifically 1,100-1,200 mAh/g(S), e.g., 1,180 mAh/g(S), per sulfur(S) weight. The DOD 15% may be a state of 15% of the total discharge capacity, and the DOD 80% may be a state of 80% of the total discharge capacity. For example, the state of DOD 15% to DOD 80% may be a state with a discharge capacity of 150-960 mAh/g(S) per sulfur(S) weight.

As described above, the lithium-sulfur battery including a compound which has the characteristic peaks in the XRD pattern in the state of DOD 15% to DOD 80% may exhibit high energy density.

Next, the components of the lithium-sulfur battery are described in detail.

### Positive Electrode

In an exemplary embodiment of the present disclosure, the positive electrode may include a positive electrode current collector and a positive electrode active material layer coated on one or both sides of the positive electrode current collector.

The positive electrode current collector is not specially limited as long as it supports the positive electrode active material and exhibits high conductivity without causing chemical change in the battery. For example, copper, stainless steel, aluminum, nickel, titanium, palladium, sintered carbon, copper or stainless steel surface-treated with carbon, nickel, silver, etc., aluminum-cadmium alloy, etc. may be used.

Fine irregularities may be formed on the surface of the positive electrode current collector to strengthen the binding force with the positive electrode active material. Various forms such as a film, a sheet, a foil, a mesh, a net, a porous body, a foam, a nonwoven, etc. may be used.

The positive electrode active material layer includes the positive electrode active material and may further include a conductive material, a binder, an additive, etc.

In an exemplary embodiment of the present disclosure, the positive electrode active material includes a sulfur-carbon composite.

In an exemplary embodiment of the present disclosure, the sulfur-carbon composite may include: a porous carbon material; and a sulfur-based compound supported on at least one of the inner pores of the porous carbon material and the external surface of the porous carbon material. Since the sulfur acting as the positive electrode active material lacks electrical conductivity on its own, it may be composited with a conductive material such as a carbon material, and a porous carbon material may be used to support the sulfur. In addition, the sulfur-based compound is added as a positive electrode active material and may include, for example, one or more of inorganic sulfur (S₈), lithium sulfide (Li₂S), lithium polysulfide (Li₂Sₓ, 1<x≤8), a disulfide compound and a carbon-sulfur polymer ((C₂S_{y})ₙ, 2.5≤y≤50, n≥2). Specifically, the sulfur-based compound may be inorganic sulfur (S₈).

In an exemplary embodiment of the present disclosure, the porous carbon material is not specially limited in type as long as it is a porous carbon material capable of improving the conductivity of the positive electrode while uniformly and stably supporting the sulfur-based compound as the positive electrode active material.

The porous carbon material may be generally prepared by carbonizing various precursors of carbon materials. The porous carbon material includes irregular pores therein. The pores may have an average diameter of 1-200 nm and a porosity corresponding to 10-90 vol % of the total volume of the porous carbon material. If the average diameter of the pores is smaller, the impregnation of sulfur is impossible because the pore size is only at a molecular level. In contrast, if the average diameter exceeds the above range, it is undesirable for preparation of an electrode because the mechanical strength of the porous carbon material is decreased.

In an exemplary embodiment of the present disclosure, the ‘average diameter of the pores’ may be measured by a method of measuring the diameter of the pores of a porous material known in the art without special limitation. For example, the diameter of the pores may be measured by scanning electron microscopy (SEM), field emission electron microscopy, laser diffraction method or BET (Brunauer-Emmett-Teller) method. The measurement using the laser diffraction method may be conducted using, for example, a commercially available laser diffraction particle size analyzer (e.g., Microtrac MT 3000). In addition, a BELSORP series analyzer (BEL Japan) may be used for measurement by the BET method, although not being limited thereto.

In an exemplary embodiment of the present disclosure, the ‘porosity’ refers to the ratio of the volume occupied by pores to the total volume of a structure in % unit, and may be used interchangeably with the terms pore ratio, degree of porosity, etc. In the present disclosure, the method for measuring porosity is not specially limited. In an exemplary embodiment of the present disclosure, it may be measured by the BET method using nitrogen gas, mercury (Hg) porosimetry or ASTM D2873.

The porous carbon material may be spherical, rod-shaped, needle-shaped, tube-shaped or bulk-type and is not limited in shape as long as it is one commonly used in a lithium-sulfur battery.

The porous carbon material may be any one commonly used in the art, which has a porous structure and a large specific surface area. For example, the porous carbon material may be one or more selected from a group consisting of graphite; graphene; carbon black such as denka black, acetylene black, ketjen black, channel black, furnace black, lamp black, thermal black, etc.; carbon nanotube (CNT) such as single-walled carbon nanotube (SWCNT), multi-walled carbon nanotube (MWCNT), etc.; carbon fiber such as graphite nanofiber (GNF), carbon nanofiber (CNF), activated carbon fiber (ACF), etc.; graphite such as natural graphite, artificial graphite, expandable graphite, etc.; and activated carbon, although not being limited thereto. Specifically, the porous carbon material may be carbon nanotube.

In an exemplary embodiment of the present disclosure, the porous carbon material may include, for example, carbon nanotube (CNT).

In an embodiment of the present disclosure, the porous carbon material may be prepared by a manufacturing method including a step of centrifugally milling a porous carbon material; and a step of filtering the centrifugally milled porous carbon material through a sieve, wherein a mesh size of the sieve is 2.8 to 4 times of a target D₅₀ particle size of the porous carbon material.

In an embodiment of the present disclosure, the porous carbon material may satisfy one or more of the following conditions: (1) a sum of particle size D₁₀ and particle size D₉₀ is 60 μm or less; and (2) a broadness factor (BF) according to the following equation is 0.7 or lower:

$$Broadness factor ( BF ) = ( {D}_{90} particle size of the porous carbon material ) / [ ( {D}_{10} particle size of the porous carbon material ) \times 10 ] .$$

In an exemplary embodiment of the present disclosure, the sulfur-carbon composite may have a sulfur/carbon (S/C) weight ratio of, for example, 2.3 g/g or higher, more specifically 2.5 g/g or higher. For example, the sulfur-carbon composite may have a sulfur/carbon weight ratio of 2.3-5 g/g, for example, 2.3-2.4 g/g. When the S/C ratio of the sulfur-carbon composite is within the above ranges, it may be advantageous in that the electron transfer ability (conductivity) and electrochemical specific surface area of the sulfur-carbon composite can be ensured. For example, it may be advantageous in that the elution of sulfur from the positive electrode is suppressed as the usable surface of the sulfur-carbon composite increases, although the present disclosure is not limited thereto.

In an exemplary embodiment of the present disclosure, The S/C weight ratio may be calculated from the weight of sulfur in gram (g) of the sulfur-carbon composite and from the weight of carbon in gram (g) of the sulfur-carbon composite. Alternatively, the S/C weight ratio may be calculated from the weight % of sulfur based on the total amount of the sulfur-carbon composite and from the weight % of carbon based on the total amount of the sulfur-carbon composite. The sulfur/carbon weight ratio (S/C weight ratio) may be dimensionless.

The sulfur-carbon composite may be prepared by a method commonly used in the art without special limitation. For example, the composite may be prepared by simply mixing sulfur and a porous carbon material and then heat-treating the mixture.

The positive electrode active material may further include one or more selected from a transition metal element, a group IIIA element, a group IVA element, sulfur compounds of these elements, and alloys of these elements with sulfur.

The transition metal element may include Sc, Ti, V, Cr, Mn, Fe, Co, Ni, Cu, Zn, Y, Zr, Nb, Mo, Tc, Ru, Rh, Pd, Os, Ir, Pt, Au, Hg, etc., the group IIIA element may include Al, Ga, In, Ti, etc., and the group IVA element may include Ge, Sn, Pb, etc.

In an exemplary embodiment of the present disclosure, the content of the sulfur-carbon composite may be 50 wt % or more based on the total weight of the positive electrode. Specifically, the content of the sulfur-carbon composite may be, for example, 80 wt % or more, 90 wt % or more or 95 wt % or more, based on the total weight of the positive electrode. The sulfur-carbon composite may be included at a content of specifically 80-100 wt %, more specifically 85-99 wt %, 90-99 wt %, 95-98 wt %, 95-97 wt % or 96 wt % based on the total weight of the positive electrode active material layer. If the content of the sulfur-carbon composite is below the above ranges, it is difficult to embody a battery with high capacity and high energy density because the relative content of subsidiary materials such as the conductive material, a binder, etc. is increased and the content of the sulfur-carbon composite is decreased. And, if the content exceeds the above ranges, there is a problem that the physical properties of the electrode are deteriorated due to the relatively low content of the conductive material or binder.

The conductive material serves as a path for electrons to move from a current collector to the positive electrode active material by electrically connecting an electrolyte and the positive electrode active material. Any material which is physically distinguished from the carbon contained in the sulfur-carbon composite and has conductivity may be used without limitation.

In an exemplary embodiment of the present disclosure, the conductive material may be, for example, carbon black such as Super-P, denka black, acetylene black, ketjen black, channel black, furnace black, lamp black, thermal black, etc.; carbon derivatives such as carbon nanotubes, fullerene, etc.; conductive fibers such as carbon fiber, metal fiber, etc.; fluorocarbons; metal powders such as, aluminum and nickel powder; conductive polymers such as polyaniline, polythiophene, polyacetylene, polypyrrole, etc.; or combinations thereof.

In an exemplary embodiment of the present disclosure, the content of the conductive material may be 0-10 wt %, for example, 1-10 wt % based on the total weight of the positive electrode active material. If the content of the conductive material is below the above ranges, voltage and capacity may decrease because the electron transfer between the positive electrode active material and the current collector is not easy. On the contrary, if it exceeds the above ranges, the total energy (charge) of the battery may decrease due to the relatively decreased proportion of the positive electrode active material. Therefore, it is preferred that an appropriate content is determined within the above ranges.

In an exemplary embodiment of the present disclosure, the binder retains the positive electrode active material in the positive electrode current collector and increases binding between them by organically connecting the positive electrode active material. Any binder known in the art may be used.

For example, as the binder, a fluorine resin-based binder including polyvinylidene fluoride (PVDF), a polyvinylidene fluoride-based polymer containing at least one vinylidene fluoride as a repeating unit, polytetrafluoroethylene (PTFE) or mixtures thereof; a rubber-based binder including styrene-butadiene rubber (SBR), acrylonitrile-butadiene rubber and styrene-isoprene rubber; an acrylic binder; a cellulose-based binder including carboxymethyl cellulose (CMC), starch, hydroxypropyl cellulose and regenerated cellulose; a polyalcohol-based binder; a polyolefin-based binder including polyethylene and polypropylene; a polyimide-based binder; a polyester-based binder; a silane-based binder; a polyacrylic acid-based binder; a polyacrylonitrile-based binder; and mixtures or copolymers thereof may be used.

In an exemplary embodiment of the present disclosure, the content of the binder may be 1-10 wt % based on the total weight of the positive electrode active material layer. If the content of the binder is below the above range, the positive electrode active material and the conductive material may be separated because the physical properties of the positive electrode worsen. And, if it exceeds the above range, the battery capacity may decrease as the relative ratio of the positive electrode active material and the conductive material in the positive electrode is decreased. Therefore, it is desired that an appropriate content is determined within the above range.

In the present disclosure, the method for preparing the positive electrode for a lithium secondary battery is not particularly limited. It may be prepared by methods known to those skilled in the art or modifications thereof.

As an example, the positive electrode for a lithium secondary battery may be prepared by preparing a positive electrode slurry composition with the composition described above and then forming a positive electrode active material layer by coating it on at least one surface of a positive electrode current collector.

The positive electrode slurry composition contains the positive electrode active material described above and may further contain a binder, a conductive material and a solvent.

As the solvent, one that can uniformly disperse the positive electrode active material is used. As the solvent, water is the most preferred as a water-based solvent. The water may be distilled water or deionized water. However, the present disclosure is not necessarily limited thereto and, if necessary, a low-grade alcohol that can be easily mixed with water may be used. As the low-grade alcohol, methanol, ethanol, propanol, isopropanol, butanol, etc. may be used, and they can be specifically mixed with water.

The content of the solvent may be at a level allowing easy coating, and the specific content varies depending on the coating method and device.

The positive electrode slurry composition may further contain materials commonly used for improving functions if necessary. For example, it may contain a viscosity modifier, a glidant, a filler, etc.

The method for coating the positive electrode slurry composition is not specially limited in the present disclosure. For example, doctor blading, die casting, comma coating, screen printing, etc. may be used. In addition, the positive electrode slurry may be formed on a separate substrate and then coated on a positive electrode current collector by pressing or lamination.

After coating, a drying process may be performed to remove the solvent. The drying process is performed under the temperature and time conditions where the solvent can be removed enough, although the conditions are not specially limited in the present disclosure. As an example, the drying may be performed by drying with warm air, hot air or low-humidity air, vacuum drying, drying by (far) infrared radiation or electron beam radiation, etc. The drying speed is usually adjusted such that the solvent can be removed as quickly as possible within a speed range that does not cause cracks in the positive electrode active material layer or peeling of the positive electrode active material layer from the positive electrode current collector due to stress concentration.

Additionally, the density of the positive electrode active material in the positive electrode may be increased by pressing the current collector after the drying. The pressing may be performed by mold pressing, roll pressing, etc.

The positive electrode, specifically the positive electrode active material layer, prepared as described above may have a porosity of 50-80 vol %, specifically 60-75 vol %. If the porosity of the positive electrode is below 50 vol %, enough electrolyte that can exhibit ionic conductivity and/or electrical conductivity cannot be maintained between the positive electrode active material because of excessively increased filling degree of the positive electrode slurry composition containing the positive electrode active material, the conductive material and the binder. As a result, the output characteristics or cycle characteristics of the battery may be negatively affected and the overvoltage and discharge capacity reduction of the battery may become severe. On the contrary, if the porosity of the positive electrode exceeds 80 vol %, adhesivity and reactivity may decrease due to decreased physical and electrical connection with the current collector and the energy density of the battery may decrease as the electrolyte is filled in the pores. Accordingly, the porosity is adjusted appropriately within the above ranges.

In an exemplary embodiment of the present disclosure, the positive electrode may have a sulfur(S) loading amount of from 2 to 5 mAh/cm². For example, the sulfur(S) loading amount of the positive electrode may be from 2.5 to 5 mAh/cm², from 3 to 4 mAh/cm² or from 3.5 to 4 mAh/cm², although the present disclosure is not limited thereto. A lithium-sulfur battery containing sulfur according to the above-described sulfur(S) loading amount may provide a lithium-sulfur battery having an improved high energy density. Furthermore, lithium-sulfur battery containing sulfur according to the above-described sulfur(S) loading amount may provide a lithium-sulfur battery with a specific lithium polysulfide compound, that may be crystalline, as it is described by XRD in the following.

The loading amount of sulfur may be a value calculated from the total weight of sulfur(S) contained as a positive electrode active material in the positive electrode and the capacity value of the electrode calculated from this. At this time, the weight of sulfur in the positive electrode may be measured from the positive electrode active material added during the manufacturing step, or may be measured through thermogravimetric analysis (TGA) on the positive electrode after manufacturing. Meanwhile, when disassembling a manufactured lithium-sulfur battery, the charged lithium-sulfur battery is disassembled under an inert atmosphere to obtain a positive electrode, and then the positive electrode is washed and dried using an appropriate cleaning solvent, and then the positive electrode active material layer is scraped off. The content of sulfur(S) derived from the active material can be measured and calculated through thermogravimetric analysis (TGA) of the obtained result, but the measurement method is not limited to this.

### Negative Electrode

The negative electrode may include a negative electrode current collector and a negative electrode active material layer coated on one or both sides of the negative electrode current collector. Alternatively, the negative electrode may be a lithium metal plate.

The negative electrode current collector is for supporting the negative electrode active material layer and is the same as described in the case of the positive electrode current collector.

The negative electrode active material layer may include, in addition to a negative electrode active material, a conductive material, a binder, etc. The conductive material, binder, etc. are the same as described above.

The negative electrode active material may include a material that can reversibly intercalate or deintercalate lithium ions (Li⁺), a material that can reversibly form a lithium-containing compound by reacting with lithium ions, lithium metal or a lithium alloy.

The material that can reversibly intercalate or deintercalate lithium ions (Li⁺) may be, for example, crystalline carbon, amorphous carbon or a mixture thereof. The material that can reversibly form a lithium-containing compound by reacting with lithium ions (Li⁺) may be, for example, tin oxide, titanium nitrate or silicon. The lithium alloy may be, for example, an alloy of lithium (Li) with a metal selected from a group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al) and tin (Sn).

Specifically, the negative electrode active material may be lithium metal, and may be specifically in the form of a lithium metal thin film or a lithium metal powder.

In an exemplary embodiment of the present disclosure, the negative electrode may have a thickness of 40-80 μm. For example, the thickness of the negative electrode may be 50-70 μm or 60 μm. The thickness of the negative electrode may be measured by any known means for measuring the thickness of the components of a battery. For example, it may be measured using a Mitutoyo's thickness meter, although not being limited thereto.

### Separator

The separator separates or insulates the positive electrode and the negative electrode from each other and enables the transport of lithium ions between the positive electrode and the negative electrode. It may be made of a porous nonconductive or insulating material and any one that is commonly used as a separator in a lithium secondary battery may be used without special limitation. The separator may be an independent member such as a film and may also be a coating layer added to the positive electrode and/or negative electrode.

Specifically, the separator may be one having low resistance to the transport of ions in the electrolyte and having excellent ability to absorb the electrolyte.

In an exemplary embodiment of the present disclosure, the separator may include a porous substrate. The porous substrate may be any porous substrate commonly used in a secondary battery and a porous polymer film may be used alone or in a laminated manner. For example, a nonwoven fabric made of a high-melting-point glass fiber, a polyethylene terephthalate fiber, etc. or a polyolefin-based porous membrane may be used, although not being limited thereto.

The material of the porous substrate is not specially limited in the present disclosure, and any porous substrate commonly used in an electrochemical device may be used. For example, the porous substrate may be made of one or more material selected from a group consisting of polyolefin such as polyethylene, polypropylene, etc., polyester such as polyethylene terephthalate, polybutylene terephthalate, etc., polyamide, polyacetal, polycarbonate, polyimide, polyether ether ketone, polyethersulfone, poly(phenylene oxide), polyphenylene sulfide, polyethylene naphthalate, polytetrafluoroethylene, polyvinylidene fluoride, polyvinyl chloride, polyacrylonitrile, cellulose, nylon, poly(p-phenylene benzobisoxazole) and polyarylate.

In an exemplary embodiment of the present disclosure, the thickness of the porous substrate is not specially limited but may be 1-100 μm, specifically 5-50 μm. Although the thickness of the porous substrate is not limited to the above ranges, if the thickness is below the lower limit described above, the separator may be damaged easily during the operation of the battery due to deteriorated mechanical properties.

In an exemplary embodiment of the present disclosure, the porous substrate may have an average pore diameter of 0.001-50 μm and a porosity 10-95 vol %, although not being specially limited thereto.

In an exemplary embodiment of the present disclosure, the separator may further include a porous coating layer which is formed on at least one side of the porous substrate and includes an inorganic particle and a binder.

In an exemplary embodiment of the present disclosure, the inorganic particle and the binder included in the porous coating layer are not specially limited as long as they are those commonly used in the porous coating layer of a separator and methods for preparing the same are not specially limited.

### Electrolyte

The electrolyte is a medium in which ions involved in the electrochemical reaction of a lithium-sulfur battery can move and includes a non-water-based solvent and a lithium salt as an electrolyte.

The electrolyte is not specially limited as long as it is one that can be used in a lithium secondary battery, specifically a lithium-sulfur battery.

In an exemplary embodiment of the present disclosure, the electrolyte may include a non-water-based solvent, a lithium salt and an additive.

In an exemplary embodiment of the present disclosure, the non-water-based solvent is not specially limited as long as it is one that can be used in a lithium-sulfur battery. For example, an ether-based solvent, an ester, an amide, a linear carbonate, a cyclic carbonate, etc. may be used.

In an exemplary embodiment of the present disclosure, the ester may be, for example, one or more selected from a group consisting of methyl acetate, ethyl acetate, propyl acetate, methyl propionate, ethyl propionate, propyl propionate, γ-butyrolactone, γ-valerolactone, γ-caprolactone, σ-valerolactone and ε-caprolactone, although not being limited thereto.

In an exemplary embodiment of the present disclosure, the linear carbonate may be, for example, one or more selected from a group consisting of dimethyl carbonate, diethyl carbonate, dipropyl carbonate, ethyl methyl carbonate, methyl propyl carbonate and ethyl propyl carbonate, although not being limited thereto.

In an exemplary embodiment of the present disclosure, the cyclic carbonate may be, for example, one or more selected from a group consisting of ethylene carbonate, propylene carbonate, 1,2-butylene carbonate, 2,3-butylene carbonate, 1,2-pentylene carbonate, 2,3-pentylene carbonate, vinylene carbonate, vinylethylene carbonate and halides thereof. The halides include, for example, fluoroethylene carbonate, etc., although not being limited thereto.

In an exemplary embodiment of the present disclosure, the non-water-based solvent may include an ether-based solvent.

In an exemplary embodiment of the present disclosure, the non-water-based solvent may include the ether-based solvent at a content of 60 vol % or more, e.g., 60-100 vol %, 70-100 vol %, 80-100 vol %, 85-100 vol %, 90-100 vol %, 95-100 vol %, 98-100 vol %, 90-98 vol % or 90-95 vol %, based on total volume of the non-water-based solvent. When the content of the ether-based solvent is within the above ranges based on the total volume of the non-water-based solvent, an advantageous effect may be achieved in terms of the solubility of the components of the electrolyte, such as the lithium salt, etc., although the present disclosure is not limited thereto.

In an exemplary embodiment of the present disclosure, the ether-based solvent may include an acyclic ether, a cyclic ether or a mixture thereof.

In an exemplary embodiment of the present disclosure, the acyclic ether may include, for example, one or more selected from a group consisting of dimethyl ether, diethyl ether, dipropyl ether, dibutyl ether, diisobutyl ether, ethyl methyl ether, ethyl propyl ether, ethyl t-butyl ether, dimethoxymethane, trimethoxymethane, dimethoxyethane, diethoxyethane, dimethoxypropane, diethylene glycol dimethyl ether, diethylene glycol diethyl ether, triethylene glycol dimethyl ether, tetraethylene glycol dimethyl ether, ethylene glycol divinyl ether, diethylene glycol divinyl ether, triethylene glycol divinyl ether, dipropylene glycol dimethylene ether, butylene glycol ether, diethylene glycol ethyl methyl ether, diethylene glycol isopropyl methyl ether, diethylene glycol butyl methyl ether, diethylene glycol t-butyl ethyl ether and ethylene glycol ethyl methyl ether. Specifically, it may include one or more selected from a group consisting of dimethyl ether, dimethoxyethane, diethoxyethane, diethylene glycol dimethyl ether, triethylene glycol dimethyl ether and tetraethylene glycol dimethyl ether, more specifically dimethoxyethane.

In an exemplary embodiment of the present disclosure, the cyclic ether may include, for example, one or more selected from a group consisting of 2-methylfuran, 1,3-dioxolane, 4,5-dimethyl-dioxolane, 4,5-diethyl-dioxolane, 4-methyl-1,3-dioxolane, 4-ethyl-1,3-dioxolane, tetrahydrofuran, 2-methyltetrahydrofuran, 2,5-dimethyltetrahydrofuran, 2,5-dimethoxytetrahydrofuran, 2-ethoxytetrahydrofuran, 2-methyl-1,3-dioxolane, 2-vinyl-1,3-dioxolane, 2,2-dimethyl-1,3-dioxolane, 2-methoxy-1,3-dioxolane, 2-ethyl-2-methyl-1,3-dioxolane, tetrahydropyran, 1,4-dioxane, 1,2-dimethoxybenzene, 1,3-dimethoxybenzene, 1,4-dimethoxybenzene and isosorbide dimethyl ether. Specifically, it may include one or more selected from a group consisting of 2-methylfuran, 1,3-dioxolane, tetrahydrofuran, 2-methyltetrahydrofuran and 2,5-dimethyltetrahydrofuran, more specifically 2-methylfuran.

In an exemplary embodiment of the present disclosure, the non-water-based solvent may include a mixture of an acyclic ether and a cyclic ether.

In an exemplary embodiment of the present disclosure, the non-water-based solvent may include dimethoxyethane (DME) and 2-methylfuran (2-MeF).

In an exemplary embodiment of the present disclosure, the volume ratio of the acyclic ether and the cyclic ether may be 5:95 to 95:5 (v/v), specifically 95:5 to 50:50, more specifically 90:10 to 70:30, 85:15 to 75:25 or 80:20 (v/v). In the present disclosure, the volume ratio corresponds to “the vol % of the acyclic ether”: “the vol % of the cyclic ether” in the ether-based solvent.

In an exemplary embodiment of the present disclosure, the non-water-based solvent may not include a carbonate-based solvent in terms of the solubility of the electrolyte. Alternatively, the non-water-based solvent may include a trace amount of the carbonate-based solvent such that the carbonate-based solvent does not affect the solubility of the lithium salt. For example, when the non-water-based solvent includes the carbonate-based solvent, the content of the carbonate-based solvent may be 3 wt % or less, 2 wt % or less, 1 wt % or less, 0.5 wt % or less or 0 wt % (i.e., not included at all) based on the total weight of the electrolyte for a lithium secondary battery.

In an exemplary embodiment of the present disclosure, the lithium salt is not specially limited as long as it is one that can be used as an electrolyte of a lithium secondary battery. The lithium salt may include, for example, one or more of LiCl, LiBr, LiI, LiClO₄, LiBF₄, LiB₁₀Cl₁₀, LiPF₆, LiCF₃SO₃, LiCF₃CO₂, LiC₄BO₈, LiAsF₆, LiSbF₆, LiAlCl₄, CH₃SO₃Li, CF₃SO₃Li, (CF₃SO₂)₂NLi, (C₂F₅SO₂)₂NLi, (SO₂F) 2NLi, (CF₃SO₂)₃CLi, lithium chloroboracite, a lithium lower aliphatic carbonate, lithium tetraphyenylborate and lithium imide.

In an exemplary embodiment of the present disclosure, the content of the lithium salt may be determined appropriately in consideration of ionic conductivity, solubility, etc. For example, the content may be 0.1-4 M, specifically 0.5-2 M. When the content of the lithium salt is within the above ranges, an advantageous effect may be exhibited in terms of ensuring ionic conductivity suitable for driving a battery, or improving the motility of lithium ions and suppressing the decomposition of the lithium salt itself due to adequate viscosity of the electrolyte, although the present disclosure is not limited thereto.

In an exemplary embodiment of the present disclosure, the additive may also include a nitrogen compound in order to improve the electrical conductivity of the electrolyte and the lifetime of the lithium-sulfur battery.

Specifically, the nitrogen compound may, for example, prevent the irreversible consumption of polysulfide by suppressing the reduction of polysulfide occurring during charge/discharge of a lithium-sulfur battery and, thereby, improve the performance of the lithium-sulfur battery, although its effect is not limited thereto.

In an exemplary embodiment of the present disclosure, the nitrogen compound is not specially limited as long as it stably forms a solid-electrolyte interphase (SEI) of the negative electrode and improves charge/discharge efficiency. For example, a nitric acid-based compound, a nitrous acid-based compound or a mixture thereof may be used.

In an exemplary embodiment of the present disclosure, the nitrogen compound may be, for example, selected from a group consisting of an inorganic nitric acid or nitrous acid-based compound such as lithium nitrate (LiNO₃), potassium nitrate (KNO₃), cesium nitrate (CsNO₃), barium nitrate (Ba(NO₃)₂), ammonium nitrate (NH₄NO₃), lithium nitrite (LiNO₂), potassium nitrite (KNO₂), cesium nitrite (CsNO₂), ammonium nitrite (NH₄NO₂), etc.; an organic nitric acid or nitrous acid-based compound such as methyl nitrate, a dialkyl imidazolium nitrate, guanidine nitrate, imidazolium nitrate, pyridinium nitrate, ethyl nitrite, propyl nitrite, butyl nitrite, pentyl nitrite, octyl nitrite, etc.; an organic nitro compound such as nitromethane, nitropropane, nitrobutane, nitrobenzene, dinitrobenzene, nitropyridine, dinitropyridine, nitrotoluene, dinitrotoluene, etc.; and combination thereof, specifically lithium nitrate.

In an exemplary embodiment of the present disclosure, the nitrogen compound may be included at a content of for example, 1 to 10 wt %, 2 to 10 wt % or 3 to 10 wt %, specifically 3 to 8 wt %, 3 to 6 wt % or 3 to 5 wt %, based on the total weight of the electrolyte, although not being limited thereto. When the content of the nitrogen compound is within the above ranges, a more advantageous effect may be exhibited in terms of improving the electrical conductivity of the electrolyte and suppressing the reduction of polysulfide when used in a lithium-sulfur battery, although the present disclosure is not limited thereto.

In an exemplary embodiment of the present disclosure, in order to embody a lithium-sulfur battery with high energy density, the weight ratio of the electrolyte and sulfur(S) in the sulfur-carbon composite of the positive electrode (El/S weight ratio) may be 2.5 g/g or lower.

In an exemplary embodiment of the present disclosure, the El/S ratio of the lithium-sulfur battery may be 1.5-2.5 g/g, specifically 2-2.5 g/g, 2-2.3 g/g, 2.0-2.2 g/g or 2.0-2.15 g/g.

In one embodiment of the present invention, the El/S ratio of the lithium-sulfur battery may be calculated by the ratio of the weight of sulfur in the sulfur-carbon composite of the positive electrode and the weight of the electrolyte added during the manufacturing process.

In another embodiment of the present invention, the El/S ratio of the lithium-sulfur battery can be calculated by the ratio of the weight of sulfur in the sulfur-carbon composite of the positive electrode and the weight of the introduced electrolyte analyzed by disassembling the battery.

In an exemplary embodiment of the present disclosure, when analyzing the El/S ratio of a lithium-sulfur battery by following steps: measuring the total weight of the lithium-sulfur battery in a charged state, then disassembling the battery, washing the positive electrode, negative electrode, separator, and case with a solvent, drying, calculating the sum of each weight of the positive electrode, negative electrode, separator, and case, and excluding the sum weight of them from the total weight of the measured battery. At this time, it is preferable to use a solvent capable of extracting the electrolyte from the positive electrode, negative electrode, separator, and case for the washing. Next, after separating the positive electrode active material layer and the current collector from the dried positive electrode, the weight of sulfur in the positive electrode can be measured by measuring the weight of sulfur derived from the sulfur-carbon complex present in the positive electrode active material layer. The El/S ratio of the lithium-sulfur battery can be calculated based on the ratio of the weight of sulfur in the sulfur-carbon composite of the positive electrode and the weight of the added electrolyte obtained in this way.

In one embodiment of the present invention, the method of measuring the weight of sulfur derived from the sulfur-carbon complex present in the positive electrode active material layer includes, for example, thermogravimetric analysis (TGA) of the result obtained by scraping the obtained positive electrode active material layer, but the measurement method is not limited to this.

In one embodiment of the present invention, the state of charge for disassembling the lithium-sulfur battery may be a fully charged state, that is, SOC 100%.

In another embodiment of the present invention, the state of charge for disassembling the lithium-sulfur battery may be SOC 95% to SOS 100%.

In one embodiment of the present invention, disassembly of the charged lithium-sulfur battery may be performed under an inert atmosphere in aspect of safety. For example, disassembly of a lithium-sulfur battery can be performed under an Ar atmosphere.

In an exemplary embodiment of the present disclosure, the lithium-sulfur battery may have Sₓ, a ratio of the sulfur(S) loading amount of the positive electrode to the weight ratio of the electrolyte solution and sulfur(S) according to the following Equation 1, of 1.4 mAh/cm² or more,

$${S}_{X} = {S}_{PE} / {S}_{EI / S} , \qquad [ Equation 1 ]$$

wherein S_{PE} is the sulfur(S) loading amount of the positive electrode in the unit of mAh/cm², and

S_{EL/S} is the weight ratio of the electrolyte solution and sulfur(S).

In an exemplary embodiment of the present disclosure, S_{X} of the lithium-sulfur battery may be from 1.4 to 10 mAh/cm².

In an exemplary embodiment of the present disclosure, S_{X} is the sulfur(S) loading amount of the positive electrode per ratio of electrolyte and sulfur, and S_{X} is 1.4 mAh/cm² or higher, preferably in a range between 1.4 and 10 mAh/cm², more preferably in a range between 1.5 and 6 mAh/cm², even more preferably in a range between 1.6 and 4 mAh/cm², especially more preferably in a range between 1.7 and 2.5 mAh/cm².

The weight ratio of the electrolyte and sulfur(S) in the sulfur-carbon composite of the positive electrode (El/S weight ratio) may be the reciprocal value of S/El, wherein S/El may reflect the concentration of sulfur in gram in the electrolyte solution in gram. Thus, S/El may be equivalent to 1/(El/S).

The positive electrode loading (S_{PE}) given in mAh/cm² also reflects a type of concentration, considering that the amount of sulfur is linked to the mAh of the lithium-sulfur battery.

Thus, S_{X} reflects the concentration of sulfur in the battery per positive electrode. The physical dimension of S_{X} is mAh/cm².

The lithium-sulfur battery fulfilling Equation 1 may provide a high energy density lithium-sulfur battery, especially when S_{X} is 1.4 mAh/cm² or higher. The lithium-sulfur battery containing the compound with characteristic XRD peaks as mentioned above may fulfill Equation 1.

In an exemplary embodiment of the present disclosure, the lithium-sulfur battery may exhibit an energy density of, for example, 400 Wh/kg or higher. Specifically, the energy density of the lithium-sulfur battery may be 420 Wh/kg or higher, more specifically 430 Wh/kg or higher.

In an exemplary embodiment of the present disclosure, the energy density of the lithium-sulfur battery may be measured by a known method without special limitation. For example, the energy density of the lithium-sulfur battery may be calculated according to the following Equation 2 after evaluating discharge capacity by discharging at 0.1C after discharging and charging at least once in a range of 1.8 to 2.7 V at room temperature.

In one embodiment of the present invention, the initial discharging and charging may be performed at a rate of 0.1C to 0.3C, respectively. Specifically, the initial discharging and charging may be performed at a rate of 0.1C to 0.2C, for example, 0.1C.

Additionally, in one embodiment of the present invention, the initial discharging and charging may be repeated three times at a rate of 0.1C, respectively.

The discharge capacity, the driving voltage and the cell weight may be measured in mAh, V and kg units, respectively, and the energy density may be calculated by the following Equation 2.

$$Energy density ( Wh / kg ) = \{ [ ( discharge capacity ( mAh ) \times driving voltage ( V ) ) / 1000 ] / ( cell weight ( kg ) ) \} \qquad [ Equation 2 ]$$

In an exemplary embodiment of the present disclosure, the room temperature may be, for example, 23 to 25° C., specifically 23° C.

In an exemplary embodiment of the present disclosure, the charge/discharge rate may be from 0.1- to 0.5 C-rate, for example, 0.3 C-rate, although not being specially limited thereto.

In an exemplary embodiment of the present disclosure, the lithium-sulfur battery may have various shapes. For example, it may be a pouch-type battery or a cylindrical battery, although not being limited thereto.

In another aspect, the present disclosure provides a method for evaluating the energy density of a lithium-sulfur battery based on diffraction angles in the XRD pattern of the lithium-sulfur battery.

The evaluation method includes a step of determining a lithium-sulfur battery including a compound having three or more characteristic peaks selected from diffraction angles (2θ values) 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2° in the X-ray diffraction (XRD) pattern at DOD 15% to DOD 80% as a battery having high energy density.

In an exemplary embodiment of the present disclosure, the battery having high energy density may be, for example, a battery having an energy density of 300 Wh/kg or higher, specifically 430 Wh/kg or higher, like in a range between 400 and 1000 Wh/kg, preferably a range between 410 and 800 Wh/kg, more preferably a range between 420 and 600 Wh/kg, even more preferably a range between 430 and 550 Wh/kg.

EXAMPLESHereinafter, specific examples are presented to help understanding the present disclosure. However, the following examples merely illustrate the present disclosure and it is obvious to those skilled in the art that various changes and modifications can be made within the scope and technical idea of the present disclosure and the changes and modifications fall within the scope of the appended claims.

### Preparation of Lithium-Sulfur Batteries

### Example 1

A sulfur-carbon composite was prepared by mixing inorganic sulfur (S₈) and carbon nanotube (CNT) (S/C weight ratio=2.33) as a positive electrode active material. A positive electrode slurry composition was prepared by mixing 96 wt % of the prepared sulfur-carbon composite with 4 wt % of PAA (polyacrylate) as a binder. After coating the positive electrode slurry composition on an aluminum current collector, a positive electrode was prepared by drying the same. The sulfur(S) loading amount of the positive electrode was 3.7 mAh/cm².

Lithium metal with a thickness of 60 μm was used as a negative electrode.

An electrode assembly was prepared by placing the positive electrode and the negative electrode to face each other and interposing a polyethylene separator with a thickness of 12 μm and a porosity of 46 vol % therebetween.

After housing the prepared electrode assembly in a pouch-type case, a lithium-sulfur battery was prepared by injecting an electrolyte wherein 0.75 M of a lithium salt (LiTFSI) and 3 wt % of lithium nitrate (LiNO₃) were dissolved in a 8:2 (v/v) mixture solvent of dimethoxyethane (DME) and 2-methylfuran (2-MeF) to an El/S ratio of 2.15 g/g.

### Comparative Example 1

A lithium-sulfur battery was prepared in the same manner as in Example 1 except that the sulfur(S) loading amount of the positive electrode was 2.7 mAh/cm² and the El/S ratio was 2.9 g/g.

### Comparative Example 2

A lithium-sulfur battery was prepared in the same manner as in Example 1 except that the sulfur(S) loading amount of the positive electrode was 3.5 mAh/cm² and the El/S ratio was 2.60 g/g.

### Comparative Example 3

A lithium-sulfur battery was prepared in the same manner as in Example 1 except that the sulfur(S) loading amount of the positive electrode was 3.5 mAh/cm² and the El/S ratio was 3.00 g/g.

### Evaluation of Battery Performance

After repeatedly charging and discharging each of the lithium-sulfur battery prepared in Example 1 and Comparative Examples 1 to 3 at 0.1 C charging rate and 0.1 C discharging rate at room temperature (23° C.) within a range of 1.8-2.7 V three times, the specific capacity of the battery was measured at 0.1 C discharging condition and the energy density (Wh/kg) of the battery was evaluated therefrom.

The S/El may reflect the concentration of sulfur in gram in the electrolyte solution in gram, and may be the reciprocal value of S/El as indicated above. Thus, S/El may be equivalent to 1/(El/S).

The sulfur(S) loading amount of the positive electrode per ratio of electrolyte and sulfur has been calculated according to Equation 1:

$${S}_{X} = {S}_{PE} / {S}_{EL / S} \qquad [ Equation 1 ]$$

wherein S_{PE} is the sulfur(S) loading amount of the positive electrode as a mAh/cm² value, S_{EL/S} is the weight ratio of the electrolyte and sulfur(S) as a dimensionless value, and wherein

S_{X} is the sulfur(S) loading amount of the positive electrode per ratio of electrolyte a sulfur.

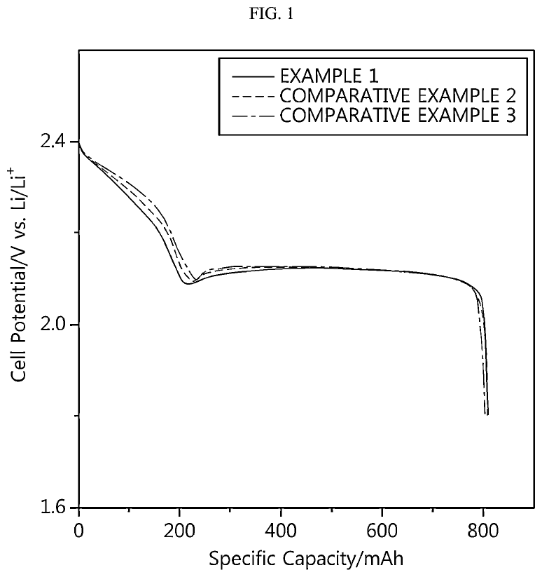

FIG. 1 shows the result of evaluating the capacity of the batteries of Example 1, Comparative Example 2 and Comparative Example 3. The energy density of the batteries of Example 1 and Comparative Examples 1-3 calculated therefrom is shown in Table 1.

$$Energy density ( Wh / kg ) = \{ [ ( discharge capacity ( mAh ) \times driving voltage ( V ) ) / 1000 ] / ( cell weight ( kg ) ) \} \qquad [ Equation 2 ]$$

TABLE 1

| | Positive electrode | El/S | | Energy |
|---|---|---|---|---|
| | sulfur (S) loading | ratio | | density |
| | amount (mAh/cm²) | (g/g) | Sx | (Wh/kg) |
| Example 1 | 3.7 | 2.15 | 1.72 | 440 |
| Comparative Example 1 | 2.7 | 2.9 | 1.35 | 350 |
| Comparative Example 2 | 3.5 | 2.60 | 1.17 | 420 |
| Comparative Example 3 | 3.5 | 3.00 | 0.93 | 400 |

### Evaluation of XRD Patterns of Batteries

The XRD patterns of the lithium-sulfur batteries prepared in Example 1 and Comparative Examples 1-3 were obtained through operando X-ray diffraction (XRD) analysis.

First, the real-time charge/discharge XRD pattern of each battery of Example 1 and Comparative Example 1 was obtained by activating by discharging at 0.1C at room temperature (23° C.) to 1.8V, charging at 0.2C to 2.7V, and then discharging at 0.1 C-rate within a range of 2.7-1.8 V.

And, the real-time charge/discharge XRD pattern of each battery of Comparative Example 2 and Comparative Example 3 was obtained by activating by discharging at 0.1C at room temperature (23° C.) to 1.8V, charging at 0.1 C to 2.7 V and then discharging at 0.1 C-rate within a range of 2.7-1.8 V.

Specifically, the XRD pattern was measured using Mo K-alpha X-ray (λ=0.709 Å) of PANalyical Empyrean XRD with 2 theta (2θ) values of 7-17 in a transmission mode. Each pattern was measured at 0.014° intervals for a total of 3 minutes. The XRD measurement was performed using a pressing jig equipped with a Be window.

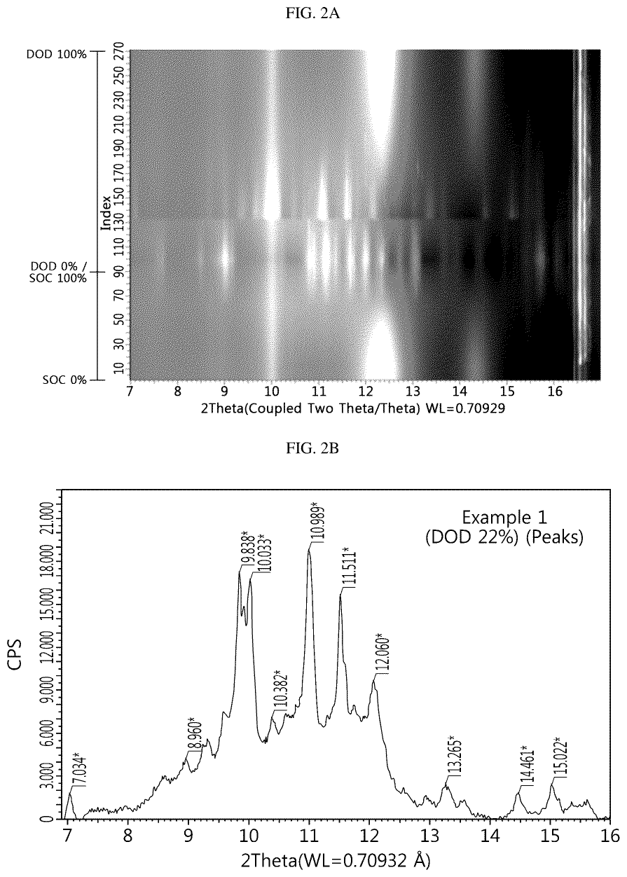

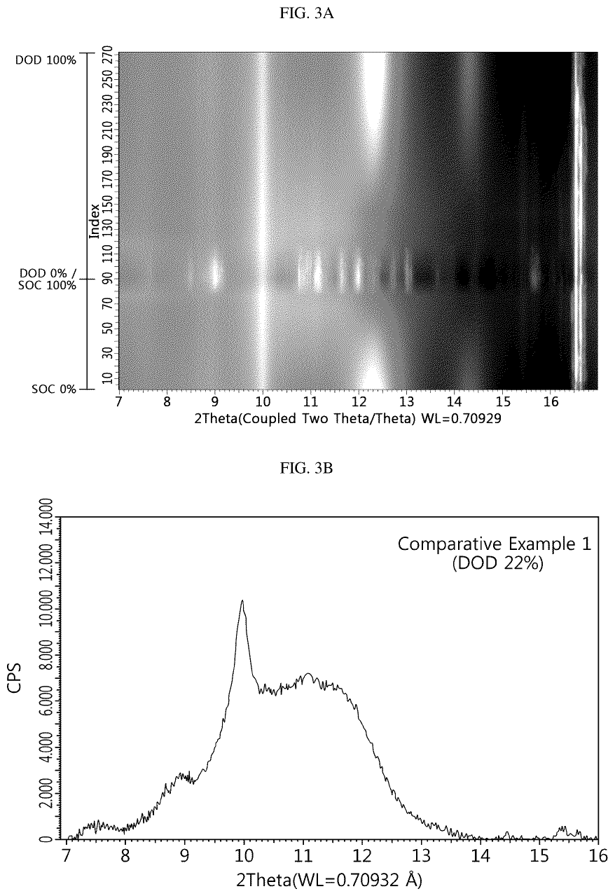

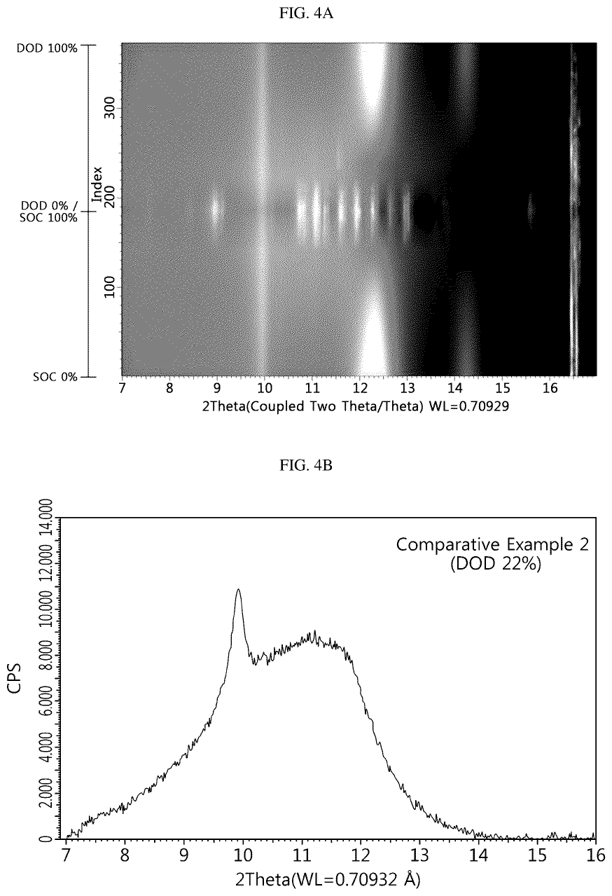

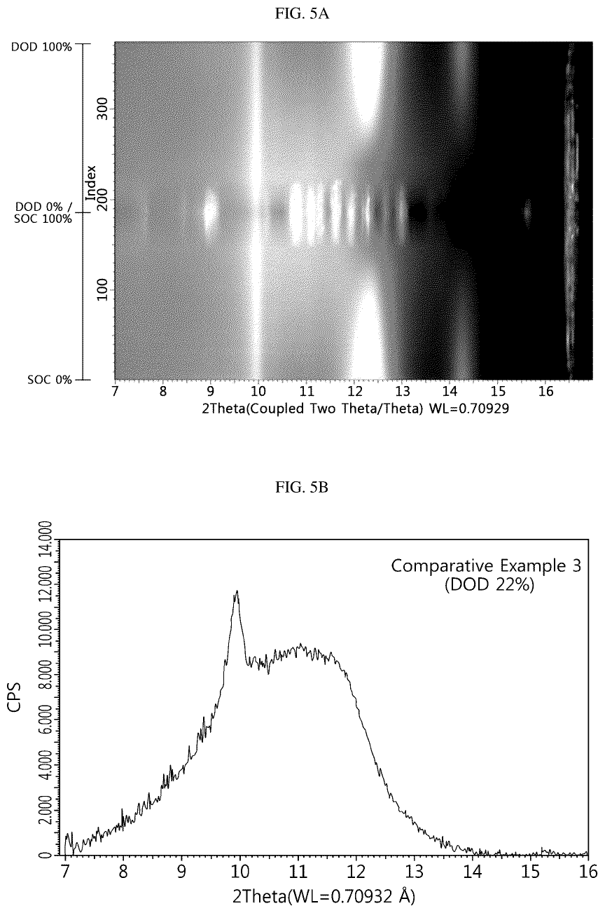

The obtained XRD pattern images are shown in FIG. 2A (Example 1), FIG. 3A (Comparative Example 1), FIG. 4A (Comparative Example 2) and FIG. 5A (Comparative Example 3).

Specifically, the XRD pattern images were obtained during 0.2C or 0.1C charging (from SOC 0% to SOC 100%) followed by 0.1C discharge (from DOD 0% to DOD 100%). That is, the XRD pattern images were obtained while operating the lithium-sulfur battery. In the XRD pattern images of FIGS. 2 to 5, index of y-axis represents time, and in the image at the top of FIG. 2 for example, the lower section of the image exhibits XRD peaks presented during 0.2C or 0.1C charging and upper section of the image exhibits XRD peaks presented during 0.1C discharging. The images of FIGS. 2B, 3B, 4B and 5B are line graphs of the XRD results corresponding to the images of FIGS. 2A, 3A, 4A and 5A, respectively.

The line graph of the XRD results shown in FIG. 2B exhibits three or more characteristic peaks labeled with the diffraction angle (20) values and indicates presence of the compound. Specifically, it was confirmed that Example 1 exhibited characteristic peaks that were not detected in Comparative Examples 1 to 3 in the range of DOD 15% (Index about 130 of FIG. 2A) to DOD 80% (Index about 230 of FIG. 2A).

Referring to FIGS. 2A and 2B, the diffraction angles of the characteristic peaks confirmed in Example 1 are as follows.

Example 1 (2θ values): 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2°, 15.0±0.2.

Referring to the images of FIGS. 3A and 3B, FIGS. 4A and 4B, and FIGS. 5A and 5B, less than three characteristic peaks among the above listed diffraction angles were observed in the region where the characteristic peaks of Example 1 were observed.

Whereas there was no significant difference in the discharge profiles of Example 1, Comparative Example 2 and Comparative Example 3 (FIG. 1) with similar level of positive electrode loading, the characteristic crystalline form was observed only in the XRD pattern of Example 1. Example 1 showed a much higher energy density as 440 Wh/kg as compared to Comparative Example 1, Comparative Example 2 and Comparative Example 3.

According to FIG. 1, which compares the discharge profiles of Example 1, Comparative Example 2, and Comparative Example 3, no significant difference in discharge capacity profiles was confirmed between them, but in the XRD patterns shown in FIGS. 2A to 5B, only Example 1 showed a specific crystalline product. At this time, when comparing the energy density of the batteries through Table 1 above, it was confirmed that there was a significant difference between them (Example 1:440 Wh/kg, Comparative Examples 2:420 Wh/kg, and Comparative Examples 3:400 Wh/kg, respectively) despite having a similar level of discharge capacity profiles.

That is, as in the equation for calculating the energy density, the weight of the batteries and the driving voltage are considered together for the energy density, and it was confirmed that it is inappropriate to estimate the energy density based on the discharge capacity alone.

Furthermore, in order to implement a lithium-sulfur battery having a property of the high energy density, it must have the characteristic of maintaining high reactivity despite solid-state reactions occurring within the battery. The characteristic peak of XRD pattern was detected only in Example 1, where the S_{X} value according to Equation 1 was 1.4 mAh/cm² or more, and it was confirmed that the battery according to Example 1 could exhibit high energy density by maintaining high reactivity even though a solid-phase reaction occurred within the battery.

Although the present disclosure has been described with limited examples and drawings, the present disclosure is not limited thereto but can be changed and modified variously within the technical idea of the present disclosure and the equivalent scope of the appended claims.

What is claimed is:

1. A lithium-sulfur battery comprising:
an electrode assembly which comprises a positive electrode including a sulfur-carbon composite, a negative electrode, and a separator between the positive electrode and the negative electrode; and
an electrolyte,
wherein the lithium-sulfur battery at depth of discharge (DOD) 15% to DOD 80% comprises a compound having three or more characteristic peaks of diffraction angles (2θ values) of X-ray diffraction (XRD) patterns selected from 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2°.

2. The lithium-sulfur battery according to claim 1, wherein the lithium-sulfur battery at DOD 15% to DOD 80% has a potential of 1.7 to 2.2 V.

3. The lithium-sulfur battery according to claim 1, wherein the DOD 15% to DOD 80% is a state having a discharge capacity per sulfur(S) weight of from 150 to 960 mAh/g(S).

4. The lithium-sulfur battery according to claim 1, wherein the compound has four or more characteristic peaks of the diffraction angles (2θ values) of XRD patterns selected from 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2°.

5. The lithium-sulfur battery according to claim 1, wherein the compound has XRD pattern diffraction angles (2θ values) of 7.1±0.2°, 9.0±0.2°, 9.4±0.2°, 9.6±0.2°, 9.9±0.2°, 10.0±0.2°, 10.4±0.2°, 11.0±0.2°, 11.6±0.2°, 12.1±0.2°, 13.3±0.2°, 14.5±0.2° and 15.0±0.2°.

6. The lithium-sulfur battery according to claim 1, wherein the sulfur-carbon composite has a sulfur/carbon (S/C) weight ratio of 2.3 g/g or more.

7. The lithium-sulfur battery according to claim 1, wherein the weight of the sulfur-carbon composite is 90 wt % or more based on the total weight of the positive electrode.

8. The lithium-sulfur battery according to claim 1, wherein the positive electrode has a sulfur(S) loading amount of from 2 to 5 mAh/cm².

9. The lithium-sulfur battery according to claim 1, wherein the negative electrode has a thickness of from 40 to 80 μm.

10. The lithium-sulfur battery according to claim 1, wherein a weight ratio of the electrolyte solution and sulfur(S) in the sulfur-carbon composite (El/S weight ratio) is 2.5 g/g or lower.

11. The lithium-sulfur battery according to claim 1, wherein the lithium-sulfur battery has an energy density of 430 Wh/kg or more.

12. The lithium-sulfur battery according to claim 1, wherein the lithium-sulfur battery is a pouch-type battery or a cylindrical battery.

13. The lithium-sulfur battery according to claim 1, wherein the lithium-sulfur battery satisfies the following Equation 1:
$${S}_{X} = {S}_{PE} / {S}_{EL / S} \qquad [ Equation 1 ]$$
wherein S_{PE} is a sulfur(S) loading amount of the positive electrode having a unit of mAh/cm²,
S_{EL/S} is a weight ratio of the electrolyte to sulfur(S), and
wherein S_{X} is the sulfur(S) loading amount of the positive electrode per the weight ratio of the electrolyte to the sulfur(S), and S_{X} is 1.4 mAh/cm² or higher.
